(19) United States
(12) Patent Application Publication
(10) Pub. No.: US 2004/0100052 A1
(43) Pub. Date: May 27, 2004

(54) Board for sporting purpose

(76) Inventor: Juan-Cheng Chou, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/301,753

(22) Filed: Nov. 22, 2002

(51) Int. Cl. B62M 1/00

(52) U.S. Cl. 280/87.041

(57) ABSTRACT

A board for sporting purpose, such as a skateboard or a surfboard, includes an upper and a lower layer, and an intermediate layer sandwiched between the upper and lower layers. The intermediate layer is formed from a plurality of elongate supporting members that extend in a longitudinal or moving direction (Y-direction) of the board and are horizontally and parallelly arranged in a transverse direction or X-direction of the board. Each supporting member has a cross section of suitable shape and dimensions, and is coated over all outer surfaces with a layer of fibrous fabric, making the whole intermediate layer a light and three-dimensionally reinforcedg layer for the board, so that the board has increased rigidity and torsional strength and reduced weight in unit thickness to provide upgraded quality for use.

### BACKGROUND OF THE INVENTION

The present invention relates to an improved board for sporting purpose, and more particularly to a board for sporting purpose having an intermediate layer formed from a plurality of elongate supporting members, which are parallelly arranged and separately coated over all outer surfaces with a layer of fibrous fabric to provide three-dimensional reinforcement to the board, so that the board has improved rigidity and torsional strength as well as reduced weight.

Skateboarding and surfboarding are very popular sports. Skateboards and surfboards for such sports are required to have considerably high rigidity and torsional strength and preferably light in weight, so that they could be easily manipulated and controlled and strong enough to bear a user's weight and impact force from different directions. FIG. 1 shows a typical skateboard 10 that is usually made of a wooden material. In an early model of the skateboard 10, seven to eleven layers of wooden plates are glued together to form the board. Each wooden-plate layer has a thickness within the range from 0.6 mm to 2.0 mm, and there is not any fiber layer included in the skateboard 10 to reinforce the structure thereof.

FIG. 2 is a sectional view taken along line A-A of FIG. 1 showing an internal structure of a conventional fiber-reinforced wooden skateboard 10. As shown, the skateboard 10 is formed from multiple layers of wooden plates 11 with a reinforcing fiber layer 12 provided over outer surfaces of the uppermost and the lowermost layer of wooden plate 11 and between any two adjacent layers of the wooden plates 11. The reinforcing fiber layers 12 enable the conventional wooden skateboard 10 to have increased rigidity and torsional strength as well as reduced weight. However, the reinforcing fiber layer 12 for the fiber-reinforced wooden skateboard 10 of FIG. 2 only provides reinforcement in two dimensions of the skateboard 10, namely, in X-direction and Y-direction. The reinforcing fiber layer 12 does not extend in Z-direction and therefore does not provide any reinforcing effect in the Z-direction of the skateboard 10.

### SUMMARY OF THE INVENTION

It is therefore a primary object of the present invention to provide a board for sporting purpose that has a three-dimensionally reinforced structure to have increased rigidity and torsional strength as well as reduced overall weight to enable upgraded quality for use.

To achieve the above and other objects, the board for sporting purpose according to the present invention mainly includes an upper and a lower layer, and an intermediate layer sandwiched between the upper and lower layers. The intermediate layer is formed from a plurality of elongate supporting members that extend in a longitudinal or moving direction (Y-direction) of the board and are horizontally and parallelly arranged in a transverse direction or X-direction of the board. Each supporting member has a cross section of suitable shape and dimensions, and is coated over all outer surfaces with a layer of fibrous fabric, making the whole intermediate layer a light and three-dimensionally reinforced layer for the board.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a typical skateboard;

FIG. 2 is a cross-sectional view taken along line A-A of FIG. 1, showing an internal structure of a conventional fiber-reinforced wooden skateboard;

FIG. 3 is a perspective view of a skateboard according to an embodiment of the present invention;

FIG. 4 is a cross-sectional view taken along line B-B of FIG. 3;

FIG. 5 is an enlarged view of the circled area of FIG. 4;

FIG. 6 is an enlarged sectional view showing an intermediate layer according to another embodiment of the present invention;

FIG. 7 shows a manner of producing the intermediate layer for the board of the present invention; and

FIG. 8 shows another manner of producing the intermediate layer for the board of the present invention.

### DETAILED DESCRIPTION OF THE PREFERRED EMBODIMENTS

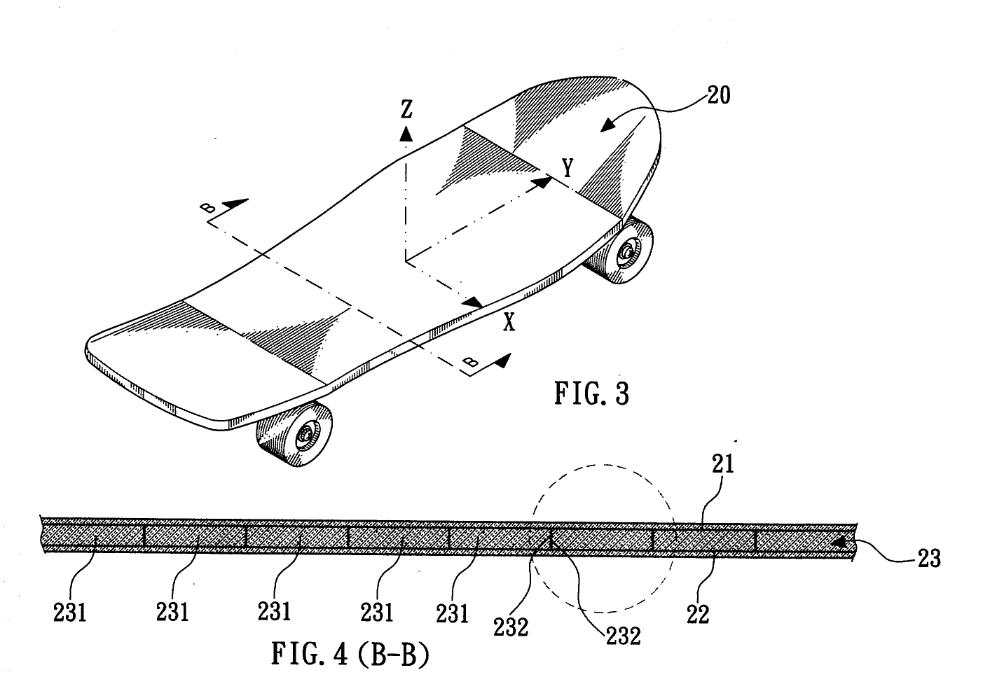

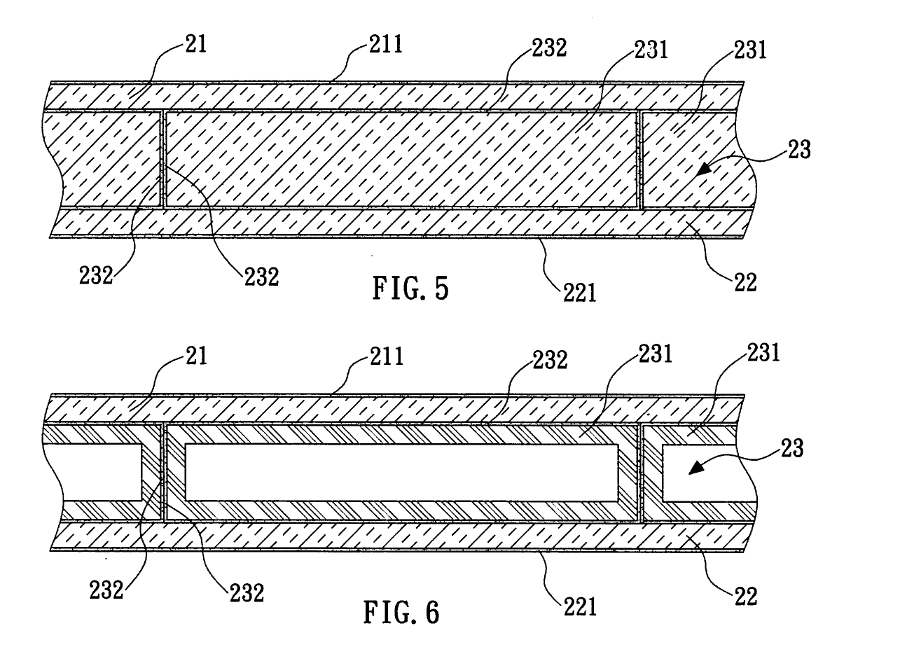

Please refer to FIG. 3 in which a skateboard 20 is shown for use as an example to describe the board for sporting purpose according to the present invention. Please also refer to FIG. 4 that is a cross-sectional view taken along line B-B of FIG. 3 to show an internal structure of the skateboard 20, and to FIG. 5 that is an enlarged view of the circled area of FIG. 4. As shown, the skateboard 20 includes a wooden upper layer 21, a wooden lower layer 22, and an intermediate layer 23 sandwiched between the upper and lower layers 21, 22.

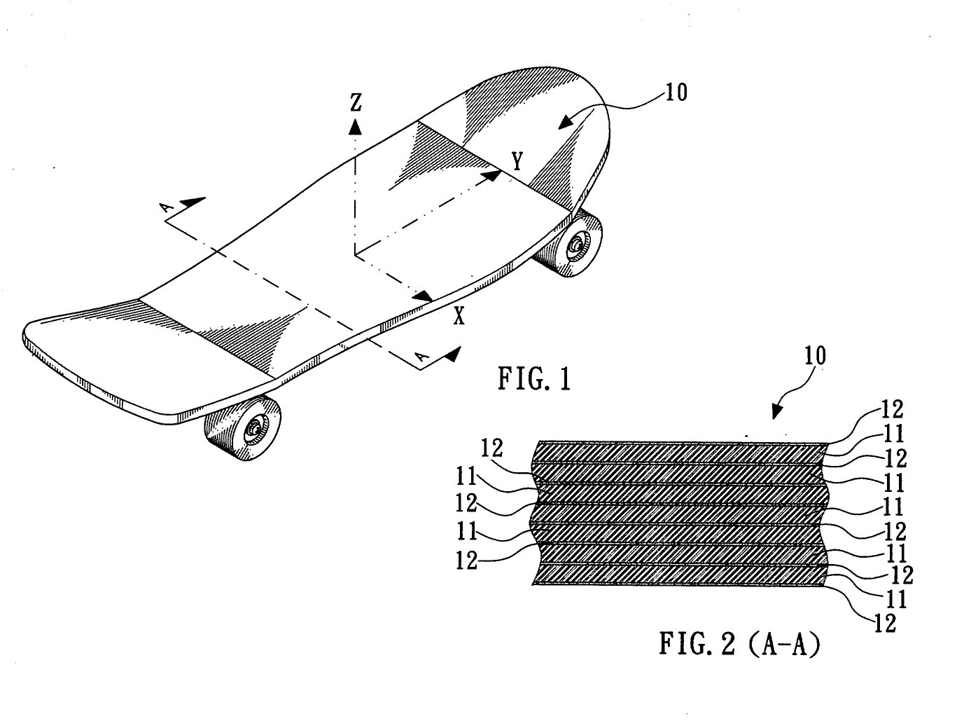

The wooden upper and lower layers 21, 22 may be the same as those for the typical skateboard 10 shown in FIGS. 1 and 2 to have a thickness within the range from 0.6 mm to 2.0 mm, and be coated with a layer of fibrous fabric 211, 221.

The intermediate layer 23 includes a plurality of elongate supporting members 231 extended by a predetermined length in Y-direction and horizontally and parallelly arranged in X-direction. The elongate supporting member 231 is made of a light and rigid material, and may be a solid member, as shown in FIG. 5, or a hollow member, as shown in FIG. 6. The material for making the elongate supporting members 231 may therefore include, for example, wood blocks or plates, rigid foamed plastics, and metal tubes, such as aluminum-extruded tubes. The elongate supporting member 231 has a rectangular cross section of suitably determined dimensions. For example, the supporting member 231 may have an overall thickness in Z-direction within the range from 0.6 mm to 15 mm, and a length in Y-direction within the range from 10 mm to 230 mm. Moreover, each elongate supporting member 231 is entirely coated with a layer of fibrous fabric 232 having a thickness of about 0.2 mm. Materials suitable for making the fibrous fabric layer 232 include glass fiber, carbon fiber, Kevlar fiber, boron fiber, titanium fiber, and the like. And, the fibrous fabric may be in the form of fiber roving, tatted fibrous fabric, knitted fibrous fabric, or other special fibrous fabrics.

In producing the intermediate layer 23, first cover the whole outer surface of each individual elongate supporting member 231 with the fibrous fabric to form the fibrous fabric layer 232. The supporting members 231 having the fibrous fabric layer 231 are then horizontally and parallelly arranged and fixed in place with fastening means, such as staples, so that an assembled body of the intermediate layer 232 is formed for convenient use in subsequent manufacturing process of the skateboard 20. The fibrous fabric layer 232 extends not only in X-direction and Y-direction to cover upper and lower side surfaces of each individual supporting member 231, but also extends in Z-direction to cover all four vertical side surfaces of the supporting member 231. Therefore, the fibrous fabric layer 232 simultaneously reinforces the elongate supporting member 231 in three directions, namely, X-, Y-, and Z-directions thereof, making the supporting members 231 much more stronger as compared with the conventional fiber-reinforced wooden skateboard 10 that is structurally reinforced in only two directions, namely, X- and Y-direction. The skateboard 20 having the intermediate layer 23 of the above-described structure indeed has increased rigidity and torsional strength as well as reduced weight in terms of one unit thickness thereof.

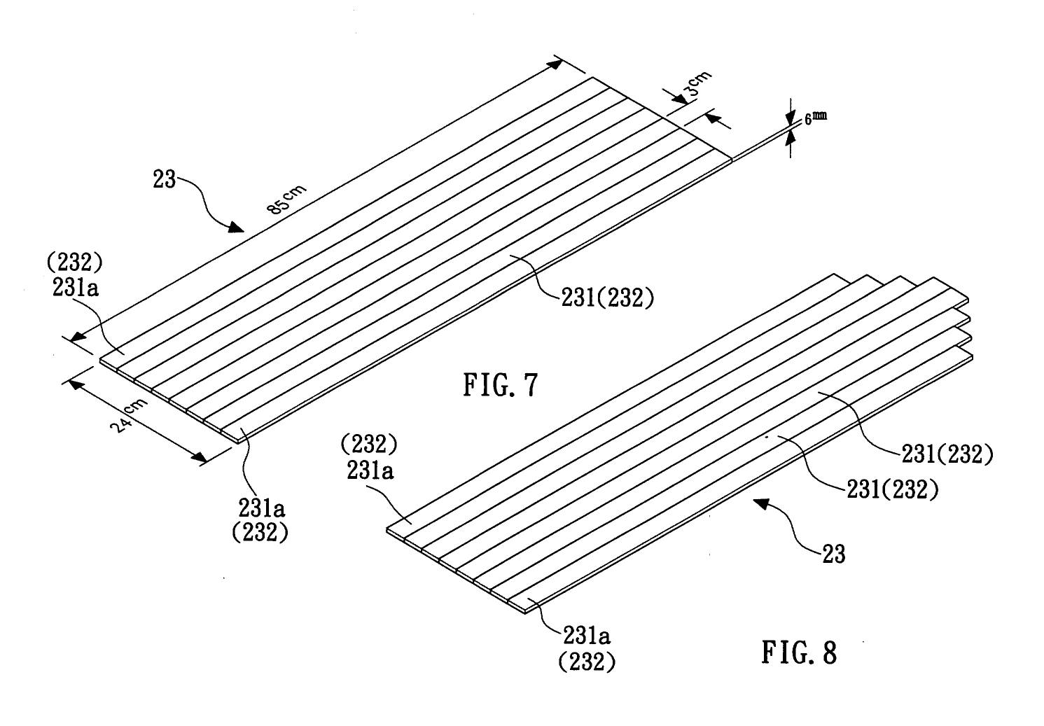

FIGS. 7 and 8 show intermediate layers 23 produced in different manners. Generally, a skateboard 20 has an overall length in Y-direction about 85 cm and an overall width in X-direction about 24 cm. Thus, the intermediate layer 23 may be formed from eight pieces of elongate supporting members 231 with each piece about 3 cm in width. Since the fibrous fabric layer 232 has a very small thickness of about 0.2 mm, it can be ignored during calculating an average width for the individual supporting members 231. The eight pieces of supporting members 231 may have either a uniform length, as shown in FIG. 7, or different lengths, as shown in FIG. 8. The supporting members 231 are then subjected to subsequent fabricating processes, such as cutting or bending into desired length and/or shape. For the skateboard 20 to have rigid and impact-proof peripheral edges, two of the eight elongate supporting members 231 that are located at two outmost sides in X-direction, as denoted by reference numeral 231a, may be otherwise made of a material having increased hardness.

Thus, the elongate supporting members 231 for the same one skateboard 20 are not limited to have the same width, length, and material. However, it is preferable the eight pieces of supporting members 231 have uniform thickness and are symmetrically arranged in X-direction.

The present invention has been described with a preferred embodiment thereof and it is understood that many changes and modifications in the described embodiment can be carried out without departing from the scope and the spirit of the invention as defined by the appended claims.

What is claimed is:

1. A board for sporting purpose, comprising a wooden upper layer, a wooden lower layer, and an intermediate layer sandwiched between said upper and lower layers; said wooden upper and lower layers forming upper and lower surfaces of said board, said intermediate layer including a plurality of elongate supporting members extended in Y-direction by a predetermined length and horizontally and parallelly arranged in X-direction, and each said elongate supporting member having a rectangular cross section of predetermined dimensions and being coated over all outer surfaces with a layer of fibrous fabric to provide a three-dimensional reinforcement to said intermediate layer and accordingly said board.

2. The board for sporting purpose as claimed in claim 1, wherein said wooden upper and lower layers are coated at respective outer surfaces with a layer of fibrous fabric.

3. The board for sporting purpose as claimed in claim 1, wherein said wooden upper and lower layers respectively have a thickness within the range from 0.6 mm to 2.0 mm.

4. The board for sporting purpose as claimed in claim 1, wherein said elongate supporting members are made of a light and rigid material.

5. The board for sporting purpose as claimed in claim 1, wherein said elongate supporting members are made of wood blocks or plates.

6. The board for sporting purpose as claimed in claim 1, wherein said elongate supporting members are made of a rigid foamed plastic material.

7. The board for sporting purpose as claimed in claim 1, wherein said elongate supporting members are made of aluminum-extruded tubes.

8. The board for sporting purpose as claimed in claim 1 or 3, wherein said elongate supporting members respectively have an overall thickness within the range from 0.6 mm to 15 mm, and a length within the range from 10 mm to 230 mm.

9. The board for sporting purpose as claimed in claim 1, wherein said fibrous fabric layer is made of a material selected from the group consisting of glass fiber, carbon fiber, Kevlar fiber, boron fiber, and titanium fiber.

10. The board for sporting purpose as claimed in claim 1, wherein said fibrous fabric layer is in a structural form selected from the group consisting of fiber roving, tatted fibrous fabric, knitted fibrous fabric, and other special fibrous fabrics.
